(19) United States
(12) Patent Application Publication
(10) Pub. No.: US 2017/0123488 A1
(43) Pub. Date: May 4, 2017

(54) TRACKING OF WEARER'S EYES RELATIVE TO WEARABLE DEVICE

(71) Applicant: Microsoft Technology Licensing, LLC, Redmond, WA (US)

(72) Inventors: Brian K. Guenter, Redmond, WA (US); John Michael Snyder, Redmond, WA (US)

(21) Appl. No.: 14/925,844

(22) Filed: Oct. 28, 2015

(51) Int. Cl. G06F 3/01; G06K 9/00; H04N 5/225; G02B 27/01; G02B 27/00

(52) U.S. Cl. CPC G06F 3/013; G02B 27/0172; G02B 27/0093; H04N 5/2256; G06K 9/0061; G06K 9/00604; G02B 2027/0138; G02B 2027/014

(57) ABSTRACT

Techniques and architectures may involve operating a wearable device, such as a head-mounted device, which may be used for virtual reality applications. A processor of the wearable device may operate by dynamically tracking the precise geometric relationship between the wearable device and a user's eyes. Dynamic tracking of eye gaze may be performed by calculating corneal and eye centers based, at least in part, on relative positions of points of light reflecting from the cornea of the eyes.

### BACKGROUND

Head-mounted devices, which may include helmets, goggles, glasses, or other configurations mountable onto a user's head, generally incorporate display and computer functionality. Head-mounted devices may provide an enhanced viewing experience for multimedia, which may be applied to training, work activities, recreation, entertainment, daily activities, playing games, or watching movies, just to name a few examples.

Head-mounted devices may track a user's head position to enable a realistic presentation of 3D scenes through the use of motion parallax, for example. Knowing the position of the user's head relative to the display, a processor of the head-mounted device may change displayed views of 3D virtual objects and scenes. Accordingly, a user may observe and inspect virtual 3D objects and scenes in a natural way as the head-mounted device reproduces the way the user sees physical objects. Unfortunately, a disparity between the actual and the measured position of the user's head relative to the display may result in erroneously or inaccurately displayed information and may adversely affect the user, who may resultantly suffer from discomfort and nausea.

### SUMMARY

This disclosure describes, in part, techniques and architectures for operating a wearable device, such as a head-mounted device, which may be used for virtual reality applications. A processor of the wearable device operates by dynamically tracking the precise geometric relationship between the wearable device and a user's eyes. Thus, for example, if the wearable device shifts on the head as the user is moving, unnatural tilt and distortion of a displayed virtual world may be avoided. Dynamic tracking of the eye gaze may be performed by calculating corneal and eye centers based, at least in part, on relative positions of points of light reflecting from the cornea of the eyes.

Herein, though examples are directed mostly to wearable devices, devices having similar or the same functionality need not be wearable. For example, dynamic tracking of eye gaze, as described herein, may be performed by a device that may be handheld, mounted on a structure separate from a subject or user, or set on a surface (e.g., tabletop), just to name a few examples. Nevertheless, the term “wearable device” will be used to encompass all such examples.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic (e.g., FPGAs, application-specific integrated circuits (ASICs), application-specific standard products (ASSPs), system-on-a-chip systems (SOCs), complex programmable logic devices (CPLDs)), and/or other technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram of an example wearable device.

FIG. 2 is a schematic cross-section diagram of an eye of a user of an example wearable device.

FIG. 3 is a schematic cross-section diagram of a portion of an example wearable device positioned relative to a user's eye.

FIG. 4 is an example image of a portion of a cornea of an eye of a user.

FIG. 5 is a schematic cross-section diagram of virtual corneal spheres superimposed on a sphere representing an eye of a user, according to an example.

FIG. 6 is a flow diagram of an example process for calculating gaze direction of an eye of a user of a wearable device.

### DETAILED DESCRIPTION

In various examples, techniques and architectures may be used to determine or track the position and/or orientation of one or both eyes of a user of a wearable device. In some examples, a device need not be wearable and the device may be associated with a subject (e.g., a human or animal), and not be limited to a user of the device. Examples of a wearable device may include a display device worn on a user's head or as part of a helmet, and may include position and/or motion sensors to measure inertial position or orientation of the wearable device. The display device may comprise a small display in front of one eye, each eye, or both eyes. The display devices may include CRTs, LCDs, Liquid crystal on silicon (LCOS), or OLED, just to name a few examples.

A wearable device may display a computer-generated image, referred to as a virtual image. For example, a processor of the wearable device may render and display a synthetic (virtual) scene so that the viewer (wearer of the wearable device) perceives the scene as reality (or augmented reality). To do this correctly, the processor may use relatively precise geometric measurements of the positional relationship between the wearable device display and the viewer's gaze, so that the processor may correctly place and orient virtual cameras in the synthetic scene. Such a positional relationship may change continuously or from time to time as the gaze of the viewer (and/or the head of the viewer) move or shift position. If the processor uses inaccurate positional relationship information, the processor may render virtual scenes that appear to tilt and distort unnaturally.

In some examples, a wearable device is configured to track the 3D location of the cornea of the eye. Such tracking is in addition to tracking the direction of a gaze (e.g., direction of looking) Thus, for example, the 3D location of the cornea or other portion of an eye includes the position of the cornea or other portion of the eye relative to each of three spatial axes, x, y, and z. Such a position may be relative to a portion of the wearable device, though claimed subject matter is not so limited.

3D tracking information of the cornea or other portion of the user's eye(s) may be continuously provided to a processor that renders images for the wearable device. Thus, the processor may render images that account for relative motion of the user's eye(s) relative to the wearable device.

3D tracking techniques described herein may provide a number of benefits. For example, 3D tracking may be performed dynamically as the user's eyes move (or are still) relative to the wearable device. Thus, a discrete calibration process involving the user is not necessary for beginning operations of the wearable device. Another benefit is that 3D tracking techniques described herein may operate by utilizing light emitters that produce relatively low intensity spots of light (e.g., glints) on the surface of the eye. Accordingly, the light emitters may operate on relatively low power, which may allow for operating a portable, battery-operated wearable device.

In some examples, a wearable device may include one or more light emitters to emit light toward one or both eyes of a user of the wearable device. Such light may be invisible to the user if the light is in the infrared portion of the electromagnetic spectrum, for example. The light impinging on the cornea of the eye(s) may produce a small spot of light, or glint, which is specular reflection of the light from the corneal surface. A camera of the wearable device may capture an image of the cornea of the eye(s) having one or more such glints. A processor of the wearable device may subsequently calculate the center of the cornea based, at least in part, on relative positions of the glints in the image. Calibration of the camera (e.g., location of aperture of camera and image plane) and relative positioning of the emitter(s), as described below, allow for such a calculation.

The camera of the wearable device may be configured to capture multiple images of the cornea as the eye (or gaze) is aligned in various directions. The processor of the wearable device may calculate the center of the cornea for each alignment direction. Subsequently, using the position of each of the centers of the cornea, the processor may calculate the center of the eye. Moreover, the processor may calculate, for a particular time, gaze direction of the eye based, at least in part, on the center of the cornea and the center of the eye. In some examples, using measurement information regarding dimensions and sizes of the average human eye, location of the cornea of the eye may be determined from the location of other portions of the eye, using offset or other geometric operations.

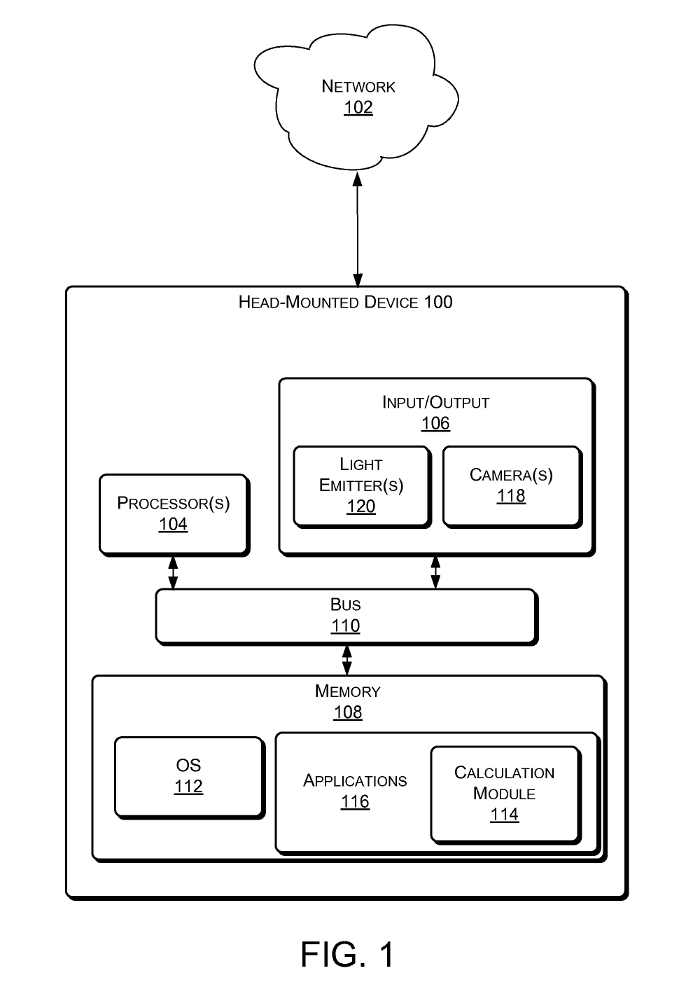

Various examples are described further with reference to FIGS. 1-6.

The wearable device configuration described below constitutes but one example and is not intended to limit the claims to any one particular configuration. Other configurations may be used without departing from the spirit and scope of the claimed subject matter.

FIG. 1 illustrates an example configuration for a wearable device 100 in which example processes involving dynamic tracking of eye movement of a user of the wearable device, as described herein, can operate. In some examples, wearable device 100 may be interconnected via a network 102. Such a network may include one or more computing systems that store and/or process information (e.g., data) received from and/or transmitted to wearable device 100.

Wearable device 100 may comprise one or multiple processors 104 operably connected to an input/output interface 106 and memory 108, e.g., via a bus 110. In some examples, some or all of the functionality described as being performed by wearable device 100 may be implemented by one or more remote peer computing devices, a remote server or servers, a cloud computing resource, external optical emitters, or external optical detectors or camera(s). Input/output interface 106 may include, among other things, a display device and a network interface for wearable device 100 to communicate with such remote devices.

In some examples, memory 108 may store instructions executable by the processor(s) 104 including an operating system (OS) 112, a calculation module 114, and programs or applications 116 that are loadable and executable by processor(s) 104. The one or more processors 104 may include one or more central processing units (CPUs), graphics processing units (GPUs), video buffer processors, and so on. In some implementations, calculation module 114 comprises executable code stored in memory 108 and is executable by processor(s) 104 to collect information, locally or remotely by wearable device 100, via input/output 106. The information may be associated with one or more of applications 116.

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some examples, wearable device 100 can be associated with camera(s) 118 capable of capturing images and/or video. For example, input/output module 106 can incorporate such a camera. Input/output module 106 may further incorporate one or more light emitters 120, such as laser diodes, light emitting diodes, or other light generating device. Herein, “light” may refer to any wavelength or wavelength range of the electromagnetic spectrum, including far infrared (FIR), near-infrared (NIR), visible, and ultraviolet (UV) energies.

Input/output module 106 may further include inertial sensors, compasses, gravitometers, or other position or orientation sensors. Such sensors may allow for tracking position and/or orientation or other movement of the wearable device (and, correspondingly, the wearer's head).

Memory 108 may include one or a combination of computer readable media. Computer readable media may include computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, or other data in a modulated data signal, such as a carrier wave, or other transmission mechanism. As defined herein, computer storage media does not include communication media. In various examples, memory 108 is an example of computer storage media storing computer-executable instructions. For example, when executed by processor(s) 104, the computer-executable instructions configure the processor(s) to, among other things, determine relative positions of glints in images captured by camera 118, and calculate the center of an eye(s) of a user of wearable device 100 based, at least in part, on determined relative positions of the glints.

In various examples, other input devices (not illustrated) of input/output module 106 can be a direct-touch input device (e.g., a touch screen), an indirect-touch device (e.g., a touch pad), an indirect input device (e.g., a mouse, keyboard, etc.), or another type of non-tactile device, such as an audio input device.

Input/output module 106 may also include interfaces (not illustrated) that allow the wearable device 100 to communicate with other devices. Such interfaces may include one or more network interfaces to enable communications between wearable device 100 and other networked devices, such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

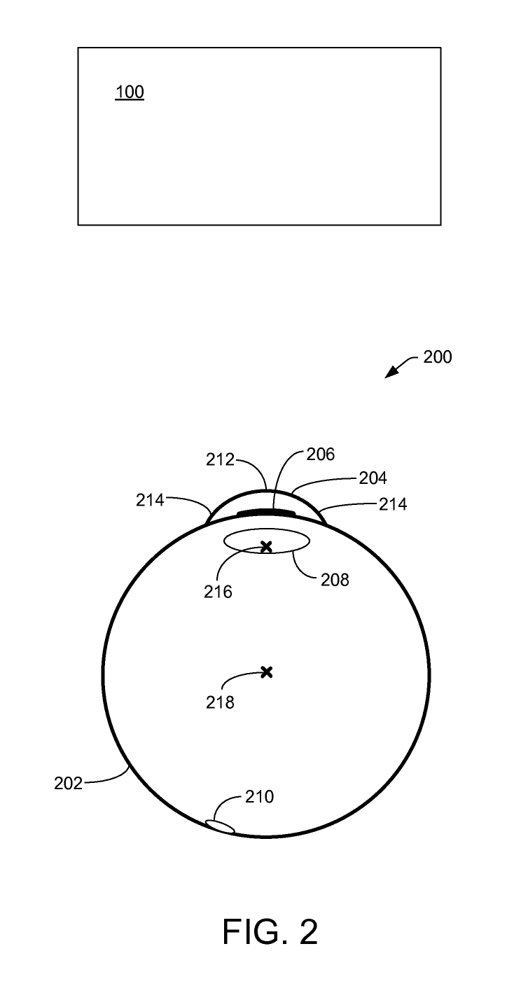

FIG. 2 is a schematic cross-section diagram of an eye 200 of a user of a wearable device, such as 100 described above. Eye 200 represents an average human (or other animal) eye. Eye 200 comprises a substantially spherical eyeball 202 that includes a cornea 204, pupil 206, lens 208, and fovea 210, among other things. A central portion 212 of cornea 204 is substantially spherical, while such sphericity tends to decrease toward peripheral regions 214 of cornea 204. Herein, a corneal sphere refers to a sphere based on the sphericity of cornea 204 around central portion 212. In other words, cornea 204 may be represented by a corneal sphere if the entire cornea were a perfect sphere having spherical parameters set forth by central portion 212. Accordingly, the corneal sphere representing cornea 204 has a center 216 inside eyeball 202.

An optical axis of eye 200 may extend from central portion 212 of the cornea and to fovea 210. Because the fovea may be offset a few degrees on the back of the eyeball, the optical axis may not go through a center 218 of the eyeball. Such an offset may be considered, as described below, if gaze direction of a user is to be determined based, at least in part, on a position of central portion 212 of the cornea.

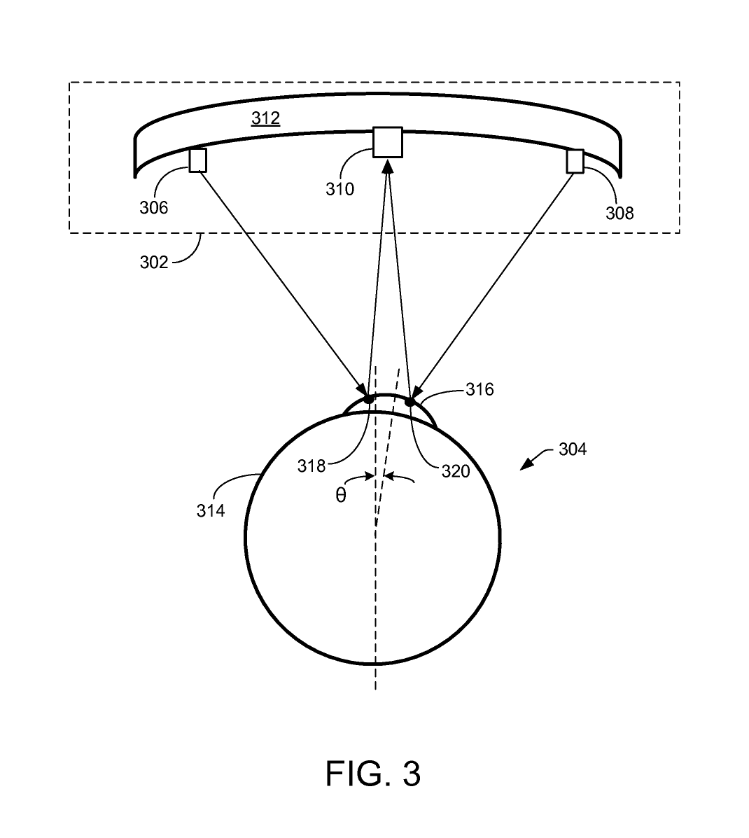

FIG. 3 is a schematic cross-section diagram of a portion 302 of an example wearable device positioned relative to a user's eye 304. Wearable device portion 302 includes light emitters 306, 308 and a camera 310 mounted or attached in some fashion to a framework 312 of wearable device portion 302. Though two light emitters are described, any number of light emitters may be used in other implementations.

Eye 304 is the same as or similar to eye 200 described above. For example, eye 304 comprises an eyeball 314 that includes a cornea 316, which may be treated as a substantially spherical shape.

Emitters 306, 308 are positioned on wearable device portion 302 so that, as the user is wearing the wearable device, the emitters may direct light onto cornea 316 for a range of rotational positions of eyeball 314. In other words, even as the eyeball rotates (e.g., as the user directs their gaze in different directions as their head position is substantially still) the emitters may shine light onto the surface of the cornea. Rotation of eyeball 314 may be indicated by θ. For example, FIG. 3 illustrates light emitter 306 directing light onto the surface of cornea 316 to create a glint 318 and light emitter 308 directing light onto the surface of cornea 316 to create a glint 320. “Glint” refers to a small area (e.g., point) that is a source of light specularly reflected from the surface. In the presently described example, an image of glint 318 created by emitter 306 (and the surface of the cornea) may be captured by camera 310 and an image of glint 320 created by emitter 308 (and the surface of the cornea) may be captured by camera 310. A single image (e.g., “photo”) of the cornea captured at a particular time may include both the image of glint 318 and the image of glint 320, as described below.

Emitters 306, 308, camera 310, and eye 304 are positioned relative to one another so that for a particular range of θ (e.g., about 15 to 40 degrees, in a particular example) glints on a substantially spherical portion of cornea 316 may be produced by the emitters and images of the glints may be captured by the camera. Beyond such a range, for example, glints in images captured by camera 310 may be on aspherical portions of the cornea or may be on eyeball 314, thus missing the cornea. Such situations are undesirable and may be avoided by judicious relative positioning of the emitters, camera, and expected position of the user's eye(s).

In addition to judicious placement of the emitters and camera relative to expected eye positions, various parameters of the camera may be considered for calibrating the emitter-eye-camera optical system. Such parameters may be focal length of the camera lens, distortion parameters of the optical system of the camera, and position of the center of the image plane of the camera with respect to the emitters(s).

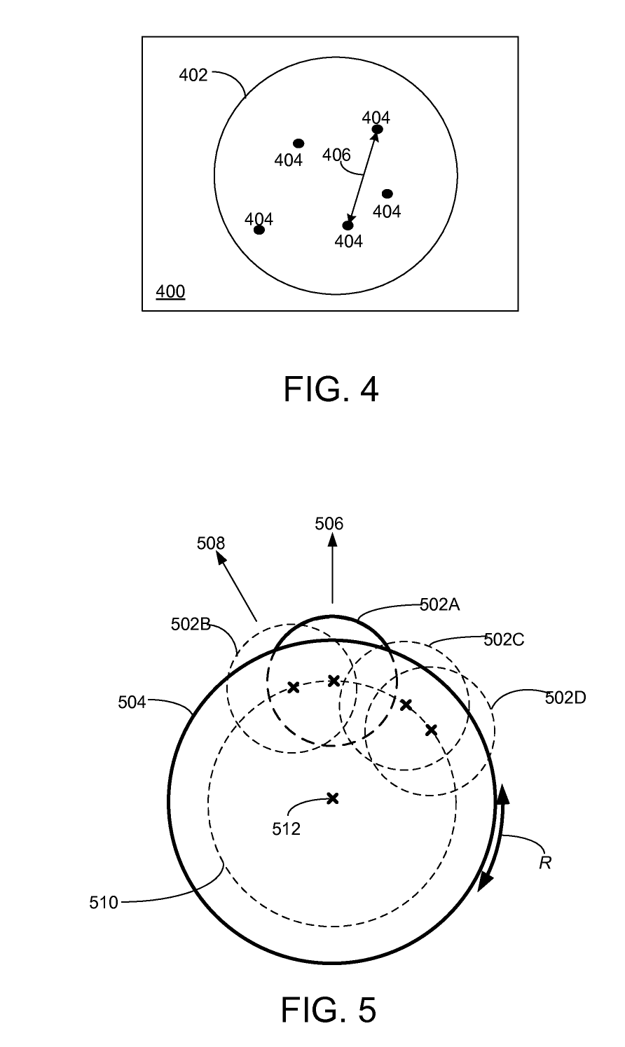

FIG. 4 is an example image 400 of a portion 402 of a cornea of an eye of a user. For example, such an image may be captured at a particular time by camera 310 illustrated in FIG. 3. The image of the cornea portion 402 includes a number of glints 404 produced by light from a number of emitters (e.g., emitters 306, 308) impinging on the surface of the cornea. Such glints may represent, in part, a position of the eye with respect to the emitters, the camera, and thus the wearable device upon which the emitters and camera are mounted or attached.

A processor (e.g., processor(s) 104) may perform image analysis on image 400 to determine positions of each glint relative to all other glints. For example, the processor may calculate a distance 406 between two glints 404. In some implementations, particular positions (e.g., x, y, and z positions) of the cornea of the eye (and the eye itself) may lead to unique sets of glint placement on the substantially spherical surface of the cornea. A wearable device system which, among other things, may include emitters and a camera, may capture an image of the cornea as the cornea is oriented in different directions (e.g., as the user of the wearable device shifts their gaze and/or moves their head relative to the wearable device). Each such image may include glints having relative positions that are unique to a particular orientation of the cornea. As described below, the processor of the wearable device may determine and track position(s) and orientation(s) of the user's eye based, at least in part, on relative positions of the glints.

In some implementations, to determine or calculate a 3D location of the cornea, the processor may implement an optimization algorithm, which may involve substantially maximizing or minimizing a real function by systematically choosing input values, such as relative locations of glints 404, location of the image place of camera 310, and location(s) of emitter(s). In some examples, optimization may involve finding “best available” values of some objective function given such input values.

FIG. 5 is a schematic cross-section diagram of virtual corneal spheres 502 superimposed on a sphere 504 representing an eye of a user, according to an example. As explained below, a virtual corneal sphere is a representation of a cornea of an eye that may be generated by a processor during a process of determining a gaze direction of an eye. Positions of each virtual cornea sphere 502 correspond to different rotational positions of the cornea and eye as the eye rotates, as indicated by arrow R. For example, virtual corneal sphere 502A corresponds to the eye and gaze looking toward direction 506. Virtual corneal sphere 502B corresponds to the eye and gaze looking toward direction 508.

A processor may generate a virtual corneal sphere based, at least in part, on positional relationships, e.g., a glint pattern, among a set of glints in an image of a cornea. For example, the processor may generate a virtual corneal sphere based on, among other things, geometrical relationships among each of the glint locations, a priori knowledge of the radius of the average human cornea (e.g., about 8.0 millimeters), calibration information regarding the camera capturing the images, and positions of light emitters.

In a particular example, a processor may generate a virtual corneal sphere based on the glint pattern illustrated in image 400 of FIG. 4. In a particular example, an image of the cornea captured when the cornea is oriented toward direction 508 may include a first glint pattern in the image. Subsequently, the processor may use a geometrical relation (e.g., equation) using the first glint pattern as input to generate virtual corneal sphere 502B. A second image, captured when the cornea is oriented toward direction 506, may include a second glint pattern in the second image. Subsequently, the processor may use the second glint pattern to generate virtual corneal sphere 502A.

Each example virtual corneal spheres, 502A, 502B, 502C, and 502D, includes a center. Such centers, indicated by “x” in FIG. 5, lie on a point cloud that forms a virtual sphere 510. As more centers of virtual corneal spheres for different eye orientations are generated by the processor, virtual sphere 510 becomes more populated with the centers. Thus accuracy of subsequent calculations based on the virtual sphere may improve because of the greater number of samples of centers. For example, such calculations may include calculating the center 512 of virtual sphere 510, which substantially corresponds to the center (e.g., 218 in FIG. 2) of the eye.

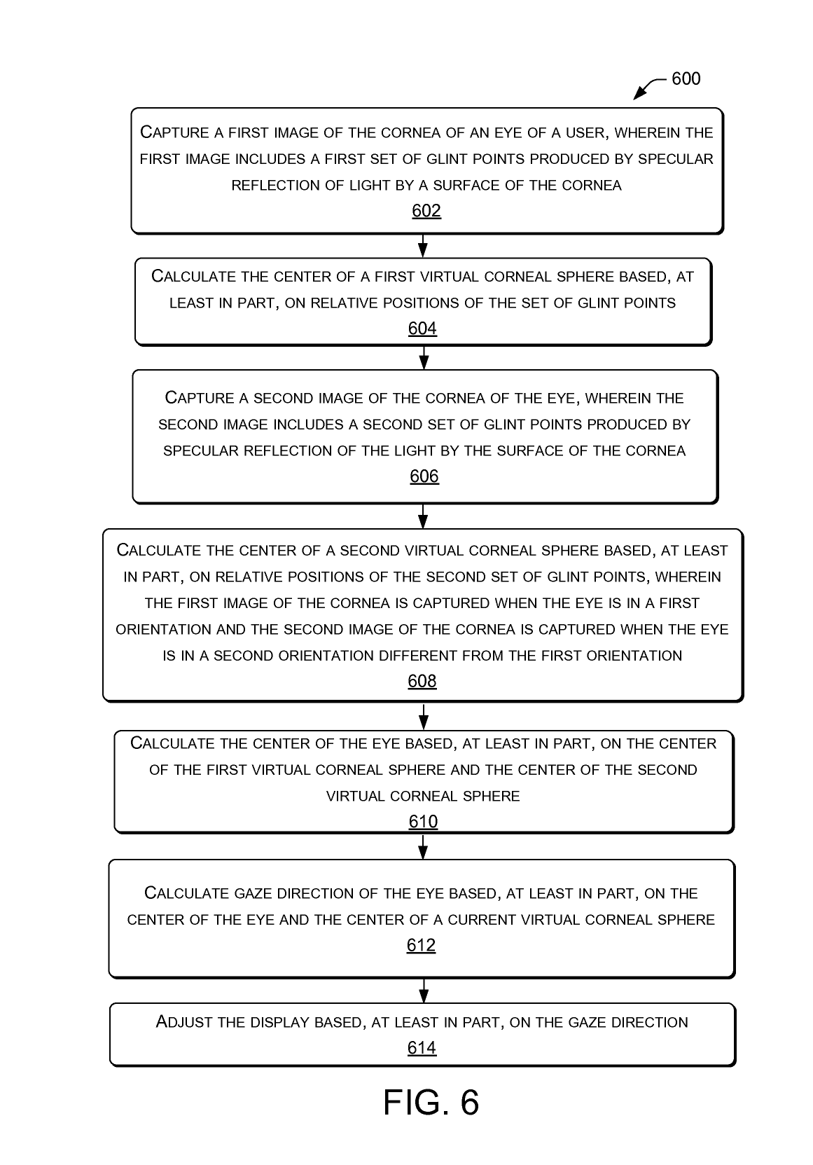

FIG. 6 is a flow diagram of an example process 600 for calculating gaze direction of an eye of a user of a head-mounted device. Process 600 may be performed by wearable device 100 illustrated in FIG. 1, for example.

At block 602, camera 118 may capture a first image of the cornea of an eye of a user of wearable device 100. The first image may include a first set of glint points produced by specular reflection of light by a surface of the cornea. At block 604, processor(s) 104 may calculate the center of a first virtual corneal sphere based, at least in part, on relative positions of the set of glint points.

At block 606, camera 118 may capture additional images of the cornea of the eye. The additional images may include additional sets of glint points produced by specular reflection of the light by the surface of the cornea. Each additional image may capture the cornea when the eye is in different rotational orientations. At block 608, processor(s) 104 may calculate the centers of additional virtual corneal spheres based, at least in part, on relative positions of the additional sets of glint points. The first image of the cornea may be captured when the eye is in a first orientation and the additional images of the cornea may be captured when the eye is in the additional orientations that differ from one another.

Process 600 may continue with block 610, where processor(s) 104 may calculate the center of the user's eye based, at least in part, on the center of the first virtual corneal sphere and the centers of the additional virtual corneal spheres. Such calculations are similar to or the same as those described for FIG. 5 above.

At block 612, processor(s) 104 may calculate gaze direction of the eye based, at least in part, on the center of the eye and the center of a current virtual corneal sphere. Such a calculation may account for an angular offset of the fovea of the human eye. At block 614, processor(s) 104 may adjust the display of the wearable device based, at least in part, on the calculated gaze direction.

### EXAMPLE CLAUSES

A. A system comprising: a light emitter to emit light toward an eye of a subject; a camera to capture an image of a cornea of the eye having one or more glints generated by reflection of the light from a surface of the eye; and a processor to: calculate a center of the cornea based, at least in part, on relative positions of the glints in the image.

B. The system as paragraph A recites, wherein the camera is configured to capture additional images of the cornea being aligned in multiple orientations, and the processor is configured to: calculate centers of the cornea for respective ones of the additional images, and calculate the center of the eye based, at least in part, on the centers of the cornea for the respective ones of the additional images.

C. The system as paragraph B recites, wherein the processor is configured to: calculate gaze direction of the eye based, at least in part, on the center of the cornea and the center of the eye.

D. The system as paragraph B recites, further comprising a display, wherein the processor is configured to adjust a display based, at least in part, on the calculated gaze direction.

E. The system as paragraph B recites, wherein a group of centers of the cornea for each of the additional images lie on a portion of a virtual sphere.

F. The system as paragraph A recites, and further comprising multiple light emitters to emit light toward the eye of the subject from different respective directions.

G. The system as paragraph A recites, wherein the system comprises a head-mounted display.

H. The system as paragraph A recites, wherein the glint comprises specularly reflected light originating from the light emitter.

I. A head-mounted device comprising: multiple light emitters configured to direct infrared light toward an eye of a wearer of the head-mounted device; a camera configured to capture images of a cornea of an eye of the wearer; a processor to: determine relative positions of glints in images captured by the camera; and calculate the center of the eye based, at least in part, on the relative positions of the glints.

J. The head-mounted device as paragraph I recites, wherein the processor is configured to calculate the center of the cornea based, at least in part, on the relative positions of the glints.

K. The head-mounted device as paragraph I recites, wherein the multiple light emitters and the camera are positioned relative to one another so that light from the multiple light emitters reflects from the cornea of the eye and enters an aperture of the camera.

L. The head-mounted device as paragraph I recites, wherein the multiple light emitters and the camera are positioned relative to one another so that, for multiple rotational positions of the eye, light from the multiple light emitters reflects from the cornea of the eye and enters an aperture of the camera.

M The head-mounted device as paragraph I recites, wherein the center of the eye is calculated by the processor with respect to at least a portion of the head-mounted device.

N. The head-mounted device as paragraph I recites, wherein relative positions of the glints in the images depend, at least in part, on rotational orientation of the eye.

O. A method comprising: capturing an image of a cornea of an eye of a subject, wherein the image includes a set of glint points produced by specular reflection of light by a surface of the cornea; and calculating the center of a virtual corneal sphere based, at least in part, on relative positions of the set of glint points.

P. The method as paragraph O recites, wherein the image is a first image, the set of glint points is a first set of glint points, and the virtual corneal sphere is a first virtual corneal sphere, the method further comprising: capturing a second image of the cornea of the eye, wherein the second image includes a second set of glint points produced by specular reflection of the light by the surface of the cornea; and calculating the center of a second virtual corneal sphere based, at least in part, on relative positions of the second set of glint points, wherein the first image of the cornea is captured when the eye is in a first orientation and the second image of the cornea is captured when the eye is in a second orientation different from the first orientation.

Q. The method as paragraph P recites, and further comprising: calculating the center of the eye based, at least in part, on the center of the first virtual corneal sphere and the center of the second virtual corneal sphere.

R. The method as paragraph Q recites, and further comprising: calculating gaze direction of the eye based, at least in part, on the center of the eye and the center of a current virtual corneal sphere.

S. The method as paragraph O recites, and further comprising: capturing a new image of the cornea of the eye when the eye has rotated to a new orientation.

T. The method as paragraph O recites, wherein the light comprises infrared light.

Although the techniques have been described in language specific to structural features and/or methodological acts, it is to be understood that the appended claims are not necessarily limited to the features or acts described. Rather, the features and acts are described as example implementations of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain examples include, while other examples do not include, the noted features, elements and/or steps. Thus, unless otherwise stated, such conditional language is not intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described examples, the elements of which are to be understood as being among other acceptable examples. All such modifications and variations are intended to be included herein within the scope of this disclosure.

What is claimed is:

1. A system comprising:
a light emitter to emit light toward an eye of a subject;
a camera to capture an image of a cornea of the eye having one or more glints generated by reflection of the light from a surface of the eye; and
a processor to:
calculate a center of the cornea based, at least in part, on relative positions of the glints in the image.

2. The system of claim 1, wherein
the camera is configured to capture additional images of the cornea being aligned in multiple orientations, and
the processor is configured to:
calculate centers of the cornea for respective ones of the additional images, and
calculate the center of the eye based, at least in part, on the centers of the cornea for the respective ones of the additional images.

3. The system of claim 2, wherein the processor is configured to:
calculate gaze direction of the eye based, at least in part, on the center of the cornea and the center of the eye.

4. The system of claim 2, further comprising a display, wherein the processor is configured to adjust a display based, at least in part, on the calculated gaze direction.

5. The system of claim 2, wherein a group of centers of the cornea for each of the additional images lie on a portion of a virtual sphere.

6. The system of claim 1, and further comprising multiple light emitters to emit light toward the eye of the subject from different respective directions.

7. The system of claim 1, wherein the system comprises a head-mounted display.

8. The system of claim 1, wherein the glint comprises specularly reflected light originating from the light emitter.

9. A head-mounted device comprising:
multiple light emitters configured to direct infrared light toward an eye of a wearer of the head-mounted device;
a camera configured to capture images of a cornea of an eye of the wearer;
a processor to:
determine relative positions of glints in images captured by the camera; and
calculate the center of the eye based, at least in part, on the relative positions of the glints.

10. The head-mounted device of claim 9, wherein the processor is configured to calculate the center of the cornea based, at least in part, on the relative positions of the glints.

11. The head-mounted device of claim 9, wherein the multiple light emitters and the camera are positioned relative to one another so that light from the multiple light emitters reflects from the cornea of the eye and enters an aperture of the camera.

12. The head-mounted device of claim 9, wherein the multiple light emitters and the camera are positioned relative to one another so that, for multiple rotational positions of the eye, light from the multiple light emitters reflects from the cornea of the eye and enters an aperture of the camera.

13. The head-mounted device of claim 9, wherein the center of the eye is calculated by the processor with respect to at least a portion of the head-mounted device.

14. The head-mounted device of claim 9, wherein relative positions of the glints in the images depend, at least in part, on rotational orientation of the eye.

15. A method comprising:
capturing an image of a cornea of an eye of a subject, wherein the image includes a set of glint points produced by specular reflection of light by a surface of the cornea; and
calculating the center of a virtual corneal sphere based, at least in part, on relative positions of the set of glint points.

16. The method of claim 15, wherein the image is a first image, the set of glint points is a first set of glint points, and the virtual corneal sphere is a first virtual corneal sphere, the method further comprising:
capturing a second image of the cornea of the eye, wherein the second image includes a second set of glint points produced by specular reflection of the light by the surface of the cornea; and
calculating the center of a second virtual corneal sphere based, at least in part, on relative positions of the second set of glint points,
wherein the first image of the cornea is captured when the eye is in a first orientation and the second image of the cornea is captured when the eye is in a second orientation different from the first orientation.

17. The method of claim 16, and further comprising:
calculating the center of the eye based, at least in part, on the center of the first virtual corneal sphere and the center of the second virtual corneal sphere.

18. The method of claim 17, and further comprising:
calculating gaze direction of the eye based, at least in part, on the center of the eye and the center of a current virtual corneal sphere.

19. The method of claim 15, and further comprising:
capturing a new image of the cornea of the eye when the eye has rotated to a new orientation.

20. The method of claim 15, wherein the light comprises infrared light.
